(19) United States
(12) Patent Application Publication
(10) Pub. No.: US 2009/0182932 A1
(43) Pub. Date: Jul. 16, 2009

(54) METHOD FOR MANAGING FLASH MEMORY BLOCKS AND CONTROLLER USING THE SAME

(75) Inventors: Wee-Tah Tan, Hsinchu City (TW); Jiunn-Yeong Yang, Keelung City (TW); Chih-Jen Hsu, Hsinchu County (TW); Wee-Kuan Gan, Hsinchu County (TW)

Correspondence Address: J C PATENTS, INC., 4 VENTURE, SUITE 250, IRVINE, CA, 92618, US

(73) Assignee: PHISON ELECTRONICS CORP., Miaoli (TW)

(21) Appl. No.: 12/053,778

(22) Filed: Mar. 24, 2008

(30) Foreign Application Priority Data
Jan. 11, 2008 (TW) 97101174

(51) Int. Cl. G06F 12/02

(52) U.S. Cl. 711/103; 711/E12.008

(57) ABSTRACT

A method for managing blocks is provided. In the method, a plurality of flash memories is divided into a plurality of block program units, and blocks mapped to each of the block program units are recorded, wherein each of the block program units maps to at least two blocks. Next, available states of the block program units are respectively determined according to good or bad states of the mapped blocks. Final, good blocks within the block program units are recorded, so as to provide the good blocks within the block program units according to the record for being written with data. Accordingly, it is possible to fully utilize the blocks in the flash memories.

### CROSS-REFERENCE TO RELATED APPLICATION

This application claims the priority benefit of Taiwan application serial no. 97101174, filed on Jan. 11, 2008. The entirety the above-mentioned patent application is hereby incorporated by reference herein and made a part of specification.

### BACKGROUND

1. Technology Field

The present invention relates to a method for managing blocks. More particularly, the present invention relates to a method for managing blocks of a flash memory and a controller using the same.

2. Description of Related Art

With a quick development of digital camera, cell phone camera and MP3, demand of storage media by customers is increased greatly. Since a flash memory has the advantages of non-volatile, energy saving, small size and none mechanical structure etc., it is suitable for portable applications, and especially for portable battery-powered products. Besides a demand of built-in memories of the portable products, demand of the flash memories used for external products such as small memory cards and flash drives is also increased greatly in the market, since a user may simultaneously own a plurality of the memory cards and the flash drives. Therefore, the flash memory industry becomes a hot industry within the electronics industry recently.

The flash memory is generally divided into a plurality of physical blocks. For convenience, the physical blocks are referred to as blocks below. Generally, the block is a minimum unit that may be erased within the flash memory. Namely, each block contains a minimum number of memory cells that may be erased together. Each block is generally divided into a plurality of pages, and the page is the minimum unit that may be programmed. In other words, the page is the minimum unit that data may be written on or read from. It should be noted that according to different designs of the flash memory, the minimum programmable unit may also be a sector, namely, the page may be divided into a plurality of the sectors, and the sector is the minimum unit that may be programmed. For example, a single level cell (SLC) NAND flash memory using a technique of number of program (NOP) being 4.

As the storage volume of the flash memory is increased, size of stored multimedia files is increased accordingly, and therefore a technique of grouping several blocks of flash memories into one block program unit for programming is developed recently. The advantages of such technique is that write efficiency of the flash memories is improved, and management complexity thereof may be simplified by utilizing the flash memories in a minimum unit of multi blocks. However, in the technique of utilizing the flash memories in the minimum unit of multi blocks, if a part of the blocks within a certain block program unit are damaged, the whole block program unit then may be regarded as a damaged block program unit and may not be utilized by the system anymore, and therefore sufficient utilization of the blocks within the flash memories may not be achieved, which may cause a waste of the storage volume.

### SUMMARY

The present invention is directed to a method for managing blocks, by which good blocks within partially applicable block program units may be provided for being written with data.

The present invention is directed to a controller applying a method for managing blocks, by which good blocks within partially applicable block program units may be provided for being written with data.

The present invention is directed to a method for managing blocks, in which good blocks within partially applicable block program units are remapped to an applicable block program unit, so as to sufficiently utilize the good blocks within a flash memory module.

The present invention is directed to a controller applying a method for managing blocks, in which good blocks within partially applicable block program units are remapped to an applicable block program unit, so as to sufficiently utilize the good blocks within a flash memory module.

The present invention provides a method for managing blocks, which is suitable for a flash memory module. In the method, a plurality of flash memories of the flash memory module is divided into a plurality of block program units, and blocks mapped to each of the block program units are recorded, wherein each of the block program units maps to at least two blocks. Next, available states of the block program units are respectively determined according to good or bad states of the mapped blocks. Final, good blocks within the block program units are recorded, so as to provide the good blocks within the block program units according to the record for being written with data.

In an embodiment of the present invention, the method for managing blocks further includes that the block program units are marked to be applicable block program units when the blocks within the block program units are all good blocks, and the block program units are marked to be partially applicable block program units when the blocks within the block program unit are partially good blocks.

In an embodiment of the present invention, the method for managing blocks further includes that the good blocks within the partially applicable block program units are respectively mapped to a block program unit for being written with data.

In an embodiment of the present invention, the method for managing blocks further includes that the good blocks within the partially applicable block program units are mapped to a block program unit in a minimum unit of designed number of blocks of each block program unit, so as to be written with data.

In an embodiment of the present invention, the blocks mapped to each of the block program units are recorded into an applicable block program unit table, and the available states of the block program units are marked into the applicable block program unit table with a plurality of flags.

In an embodiment of the present invention, the good blocks within the partially applicable block program unit are recorded into a partially applicable block table.

In an embodiment of the present invention, the method for managing blocks further includes that the applicable block program unit table and the partially applicable block table are stored into system blocks of the flash memory.

The present invention provides a flash memory controller, which is suitable for being applied to a storage device having a flash memory module. The flash memory controller includes a micro processing unit, a flash memory interface, a buffer memory and a memory management module. The flash memory interface is used for accessing the flash memory module. The buffer memory is used for temporarily storing data. The memory management module is used for dividing a plurality of flash memories of the flash memory module into a plurality of block program units, recording blocks mapped to each of the block program units, wherein each of the block program units maps to at least two blocks. Moreover, the memory management module respectively determines available states of the block program units according to good or bad states of the mapped blocks, and records good blocks within the block program units, and meanwhile provides the good blocks within the block program units according to the record for being written with data when writing data in flash memories.

In an embodiment of the present invention, the memory management module marks the block program units to be applicable block program units when the blocks within the block program units are all judged to be good blocks, and marks the block program units to be partially applicable block program units when the blocks within the block program unit are judged to be partially good blocks.

In an embodiment of the present invention, the memory management module respectively maps the good blocks within the partially applicable block program units to a block program unit for being written with data.

In an embodiment of the present invention, the memory management module maps the good blocks within the partially applicable block program units to a block program unit in a minimum unit of designed number of blocks of each block program unit for being written with data.

In an embodiment of the present invention, the memory management module records the blocks mapped to each of the block program units into an applicable block program unit table, and respectively marks available states of the block program units into the applicable block program unit table with a plurality of flags.

In an embodiment of the present invention, the memory management module records the good blocks within the partially applicable block program unit into a partially applicable block table.

In an embodiment of the present invention, the memory management module stores the applicable block program unit table and the partially applicable block table into system blocks of the flash memory.

In an embodiment of the present invention, the flash memories are single level cell (SLC) NAND flash memories or multi level cell (MLC) NAND flash memories.

In an embodiment of the present invention, the storage device is a USB flash disk, a flash memory card or a solid state drive.

In the present invention, since the applicable block program unit table and the partially applicable block table are applied for recording the applicable blocks within the partially applicable block program units, the applicable blocks then may be sufficiently utilized by the flash memory storage device, and therefore waste of a storage volume may be avoided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a flash memory storage device according to a first embodiment of the present invention.

FIG. 2 is a flowchart illustrating a method for managing blocks according to a first embodiment of the present invention.

FIG. 3A is schematic diagram illustrating damaged blocks of a flash memory module.

FIG. 3B is schematic diagram of an applicable block program unit table.

FIG. 3C is a schematic diagram of a partially applicable block table.

FIG. 4 is a flowchart illustrating a method for managing blocks according to a second embodiment of the present invention.

FIG. 5 is a schematic diagram of a renewed applicable block program unit table.

### DESCRIPTION OF EMBODIMENTS

In a structure where a plurality of blocks is taken as a minimum unit (i.e. a block program unit includes a plurality of the blocks) for being written into a flash memory, when a damaged block program unit is judged to be partially applicable, good blocks within the damaged block program unit are recorded for being utilized by a system thereof. Consequently, the blocks within the flash memory may be sufficiently utilized, and waste of a storage volume may be avoided. In the following content, embodiments are described more fully with reference to the accompanying drawings.

### First Embodiment

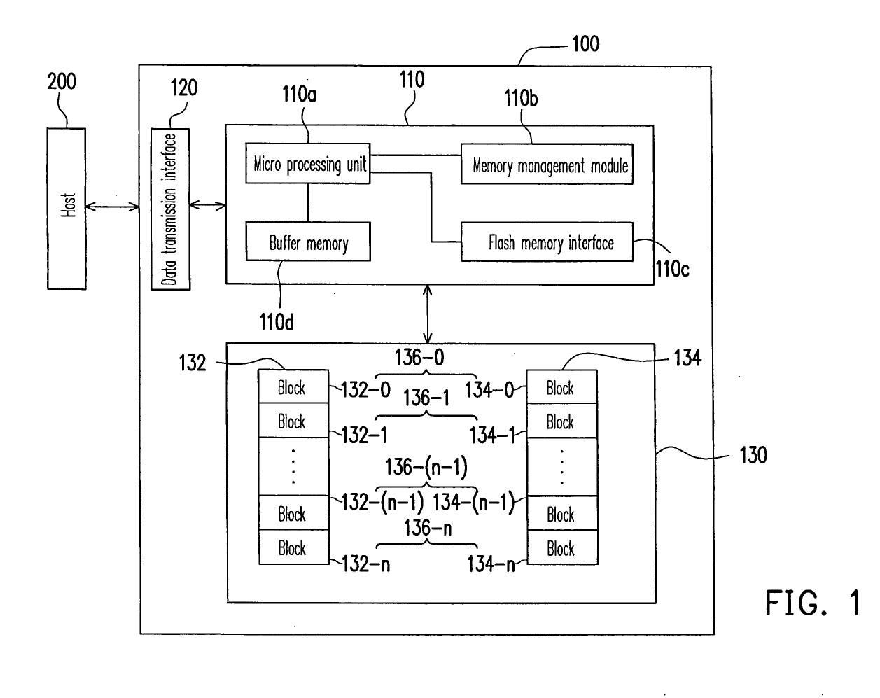

FIG. 1 is a schematic block diagram illustrating a flash memory storage device according to a first embodiment of the present invention. Referring to FIG. 1, the flash memory storage device 100 includes a controller 110, a data transmission interface 120 and a flash memory module 130. The flash memory storage device 100 is generally used together with a host 200, such that the host 200 may write data into or read data from the flash memory storage device 100. In the present embodiment, the flash memory storage device 100 is a USB flash disk. It should be noted that in another embodiment of the present invention, the flash memory storage device 100 may also be a memory card or a solid state drive (SSD).

The controller 110 controls operations of other components in the flash memory storage device 100, for example, data storage, data reading or data erasing etc. The controller 110 includes a micro processing unit 110a, a memory management module 110b, a flash memory interface 110c and a buffer memory 110d.

The micro processing unit 110a controls operations of other components in the controller 110.

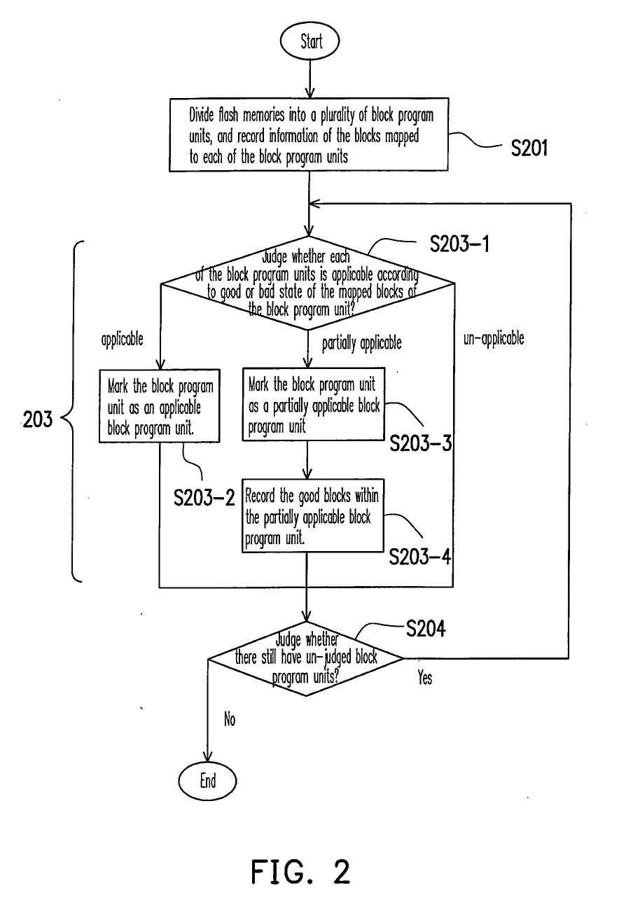

The memory management module 110b is electrically connected to the micro processing unit 110a, and is used for managing the flash memory 130, for example, executing a wear levelling method, managing damaged blocks, maintaining a mapping table etc. Especially, in the present embodiment, the memory management module 110b may execute some steps for managing blocks according to the present embodiment (shown as FIG. 2).

The flash memory interface 110c is electrically connected to the micro processing unit 1110a for accessing the flash memory 130. Namely, data to be written into the flash memory 130 by the host 200 is first transformed into a format that may be accepted by the flash memory 130 via the flash memory interface 110c.

The buffer memory 110d is used for temporarily storing a system data (for example, a logical physical mapping table) or data to be read or written by the host 200. In the present embodiment, the buffer memory 110d is a static random access memory (SRAM). However, it should be noted that the present invention is not limited thereto, and a dynamic random access memory (DRAM), a magnetoresistive random access memory (MRAM), a phase change random access memory (PRAM) or other suitable memories may also be applied.

Moreover, though not being illustrated, the controller may further include other functional modules commonly used in the flash memory, such as an error correction module and a power management module etc.

The data transmission interface 120 is electrically connected to the controller 110 for connecting to the host 200. The data transmission interface 120 may be a USB interface, an IEEE 1394 interface, a SATA interface, a PCI Express interface, a MS interface, a MMC interface, a SD interface, a CF interface, or an IDE interface.

The flash memory module 130 is electrically connected to the controller 110 for storing data. In the present embodiment, the flash memory module 130 is composed of two MLC NAND flash memories 132 and 134. However, the present invention is not limited thereto, in another embodiment of the present invention, the flash memory module 130 may include more than two of the MLC NAND flash memories. Moreover, the flash memory module 130 may also be composed of a plurality of SLC NAND flash memories or at least one SLC NAND flash memory and at least one MLC NAND flash memory.

The flash memory 132 includes a plurality of blocks 132-0 to 132-n, and the flash memory 134 includes a plurality of blocks 134-0 to 134-n. As described above, since the block is technically a minimum unit that may be erased within the flash memory, the flash memory is managed based on blocks. However, as the storage volume of the flash memory is increased, size of stored multimedia files is increased accordingly. Therefore, in the present embodiment, the flash memory is programmed and managed based on the block program unit including a plurality of the blocks.

To be specific, the memory management module 110b respectively groups the block 132-0 and the block 134-0, the block 132-1 and the block 134-1, . . . , the block 132-(n-1) and the block 134-(n-1), and the block 132-n and the block 134-n within the flash memory module 130 into the block program units 136-0˜136-n. For example, when the controller 110 writes data into the block program unit 136-0 of the flash memory module 130, the data is written into the block 132-0 and the block 134-0 based on an interleave method or a parallel method, wherein writing data into different blocks within the flash memory module based on the interleave method or the parallel method is a common technique for those skilled in the art, and therefore detailed description thereof will not be repeated.

It should be noted that grouping method of the block program unit is not limited to one to one correspondence according to a sequence of block addresses within the flash memory as that described in the present embodiment. For example, in another embodiment of the present invention, the block 132-0 and the block 134-1 may be grouped into a block program unit, and the block 132-1 and the block 134-0 may be grouped into another program unit etc.

In the flash memory storage device of the present embodiment, the memory management module 110b of the controller 110 may execute steps for managing blocks of the present embodiment, so as to avoid waste of other applicable blocks when a certain block within the block program unit is damaged and cannot be used.

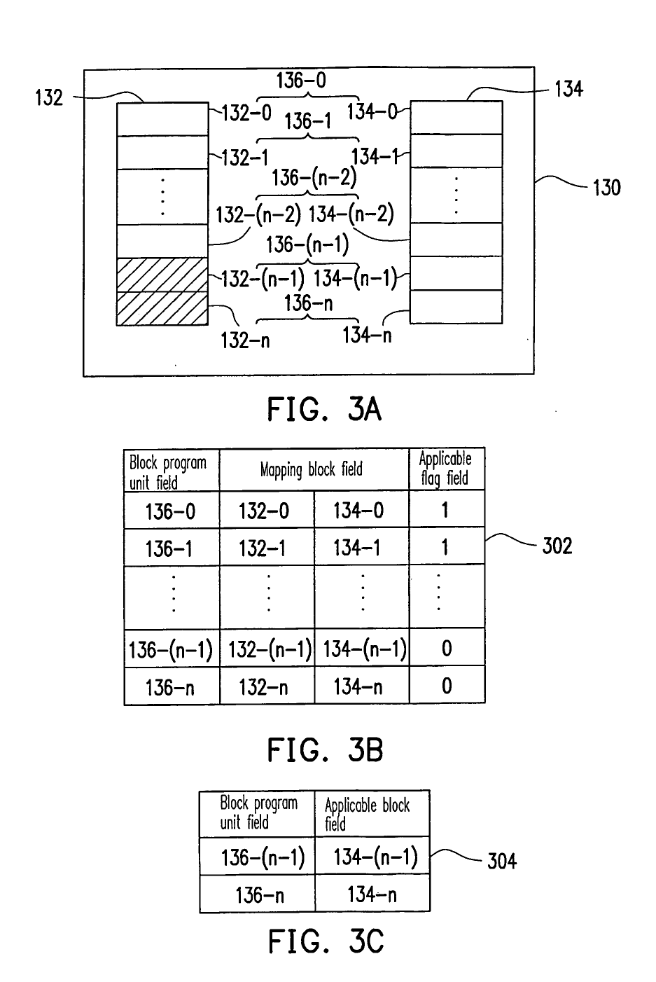

FIG. 2 is a flowchart illustrating a method for managing blocks according to a first embodiment of the present invention. FIG. 3A is schematic diagram illustrating damaged blocks of the flash memory module 130.

Referring to FIG. 2 and FIG. 3A, when the flash memory module 130 of the flash memory device 100 is initialized, in step S201, the flash memories of the flash memory module 130 are divided into a plurality of block program units according to a design of the flash memory module 130, and information of the blocks mapped to each of the block program units are recorded. For example, the flash memory module 130 is composed of two MLC NAND flash memories 132 and 134, as described above, each block program unit includes two blocks, and such information may be recorded into an applicable block program unit table (shown as FIG. 3B).

FIG. 3B is schematic diagram of an applicable block program unit table. Referring to FIG. 3B, a mapped block field in the applicable block program unit table 302 records the blocks mapping to the block program units recorded in a block program unit field. For example, the recorded block program unit 136-0 in the applicable block program unit table 302 is mapped to the block 132-0 and the block 134-0.

In step S203, a good or bad state of each block program unit is judged and recorded, and the good blocks within the block program units are recorded. To be specific, in step S203-1, whether each of the block program units is applicable is judged according to the good or the bad state of the mapped blocks of the block program unit. If the blocks of the block program unit is all judged to be good blocks according to the step S203-1, in step S203-2, this block program unit is then marked as an applicable block program unit; if the blocks of the block program unit is judged to be partially good blocks according to the step S203-1, in step S203-3, this block program unit is then marked as a partially applicable block program unit, wherein the so-called partially good blocks means that a part of the blocks within the block program unit are good blocks, and another part of the blocks within the block program unit are damaged blocks.

For example, as shown in FIG. 3A, all the blocks are good blocks besides the block 132-(n-1) and the block 132-n. Therefore, according to the steps S203-1˜S203-3, the block program units 136-1˜136-(n-2) are judged to be the applicable block program units and are marked as flags of “1” in a corresponding applicable flag field of the applicable block program unit table 302. Correspondingly, the block program units 136-(n-1) and 136-n are judged to be the partially applicable block program units and are marked as flags of “0” in the corresponding applicable flag field of the applicable block program unit table 302. Certainly, in an embodiment of the present invention, the flag “1” may also represent the damaged block program unit, and the flag “0” represents the partially applicable block program unit, while no mark represents the normally applicable block program unit. Alternatively, only the partially applicable block program units may be marked, and the damaged blocks therein may be managed by a damaged block management unit (not shown). In other words, marking rules of the flags are not limited by the present embodiment. It should be noted that there may be a situation that all the blocks within the block program unit are detected to be damaged when the memory blocks are checked, and now this block program unit is not recorded into the applicable block program unit table 302, so as to prevent being written with data by the host. In other words, when writing data into the flash memory device 100, the memory management module 110b of the controller 110 may provide the normally applicable block program units while referring to the applicable block program unit table 302.

Next, in step S203-4, the good blocks within the partially applicable block program units are recorded, and are respectively mapped to a block program unit for being written with data. For example, the good blocks within the partially applicable block program units are recorded in a partially applicable block table 304. FIG. 3C is a schematic diagram of the partially applicable block table 304. Referring to FIG. 3C, and with reference of FIG. 3A and FIG. 3B, since the block program units 136-(n-1) and 136-n are marked as the partially applicable block program units in FIG. 3B, the blocks 134-(n-1) and 134-n within the block program units 136-(n-1) and 136-n are then recorded in the applicable block field of the partially applicable block table 304 as the normally applicable blocks.

Finally, in step S204, whether there still have un-judged block program units is judged. If yes, the step S203 is repeated until all the block program units are judged.

It should be noted that the applicable block program unit table 302 and the partially applicable block table 304 may be stored within a non-volatile memory when operation of the flash memory storage device 100 is about to be stopped, so as to provide the two tables 302 and 304 to the flash memory storage device 100 for a next utilization. For example, the applicable block program unit table 302 and the partially applicable block table 304 may be stored into system blocks (not shown) of the flash memory module 130, wherein the system blocks of the flash memory module 130 is generally used for storing system data (for example, a logical physical mapping table, firmware codes etc.) of the flash memory storage device. Accordingly, the aforementioned judgement process may be performed when the flash memory module is initialized, and if the damaged blocks are detected during operation of the flash memory storage device 100, such information are only required to be directly renewed within the applicable block program unit table 302 and the partially applicable block table 304.

Accordingly, in a flash memory storage device structure using the block program units including the plurality blocks for programming and managing, by applying the method for managing blocks of the present embodiment, when data is about to be written by the host 100, the memory managing module 110b may provide the normally applicable block program units to the host 100 for being written with the data according to the applicable block program unit table 302 and the partially applicable block table 304. For example, when writing data into the flash memory device 100, the memory management module 110b may detect that the block program units 136-0˜136-(n-1) are normally applicable, and the block program units 136-(n-1) and 136-n may only provide a storage volume of the blocks 134-(n-1) and 134-n, according to the applicable block program unit table 302 and the partially applicable block table 304. Consequently, the data to be written by the host 100 then may be written into the flash memory module 130.

In summary, in the flash memory storage device structure using the block program units including the plurality blocks for programming and managing, the good blocks within the partially applicable block program units may still be utilized, so that the good blocks within the flash memory module may be sufficiently utilized, and waste of the storage volume is then avoided.

### Second Embodiment

In the first embodiment, the partially applicable block program units are utilized in a relatively small volume mode. Compared to the first embodiment, in the present embodiment, the partially applicable block program units are remapped to an integrated block program unit by adjusting the applicable block program unit table, so as to sufficiently utilize the good blocks within the flash memory module. In the following content, an embodiment is described more fully with reference to the accompanying drawings.

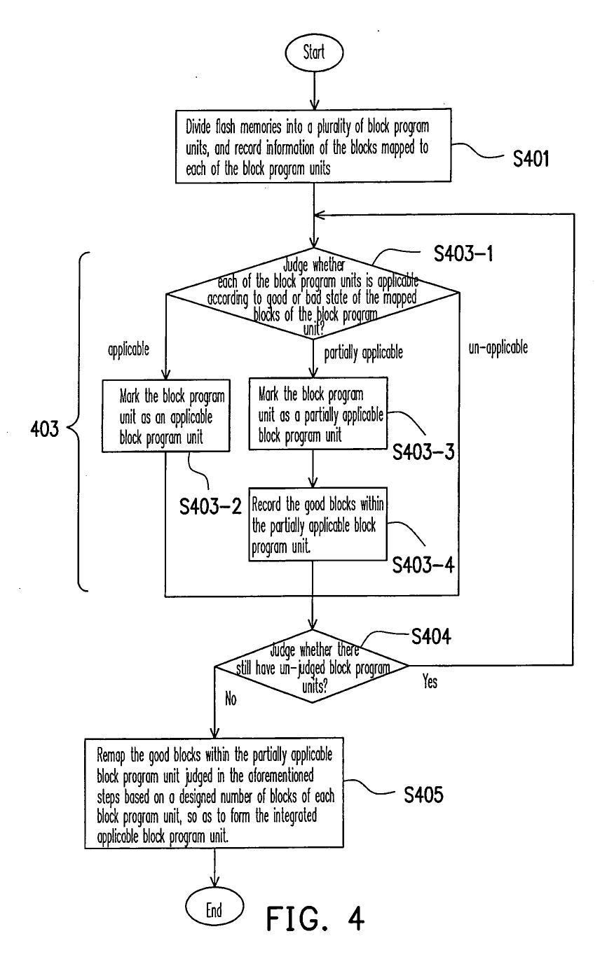

A hardware structure of the present embodiment is the same to that of the first embodiment (as shown in FIG. 1), and therefore detailed description thereof will not be repeated. FIG. 4 is a flowchart illustrating a method for managing blocks according to a second embodiment of the present invention.

Referring to FIG. 4, steps S401˜S404 are the same to the steps S201˜S204 of the first embodiment, and therefore detailed description thereof will not be repeated. In step S405, the good blocks within the partially applicable block program unit judged in the aforementioned steps are remapped based on a designed number of blocks of each block program unit, so as to form the integrated applicable block program unit for being written with data by the host 200.

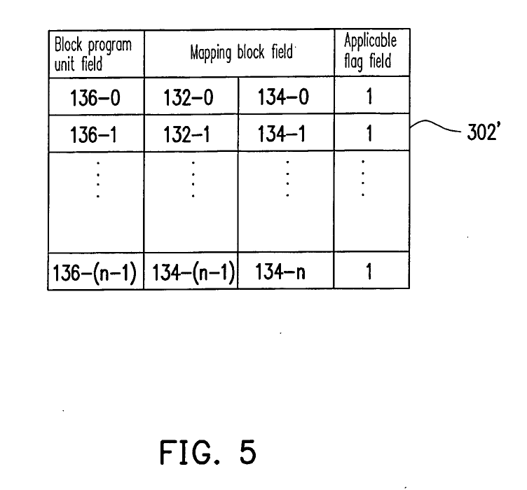

FIG. 5 is a schematic diagram of a renewed applicable block program unit table. For example, with reference of FIGS. 3A˜3C, after recording the good blocks within the partially applicable block program unit, in step S405, the normally applicable blocks 134-(n-1) and 134-n are remapped to the block program unit 136-(n-1) according to the partially applicable block table 304, and the applicable block program unit table 302 of FIG. 3 is renewed to be the applicable block program unit table 302′ of FIG. 5, and meanwhile the flag field of the block program unit 136-(n-1) is renewed to be “1”.

Accordingly, in a flash memory storage device structure using the block program units including the plurality blocks for programming and managing, by applying the method for managing blocks of the present embodiment, when data is about to be written by the host 100, the memory managing module 110b may provide the normally applicable block program units to the host 100 for being written with data according to the applicable block program unit table 302. For example, when writing data into the flash memory device 100, the memory management module 110b may provide a storage volume of the block program units 136-1 and 136-(n-1) for being written with data by the host 100.

In summary, in the present invention, by applying the applicable block program unit table and the partial applicable block table for managing the block program units, in the flash memory storage device structure using the block program units including the plurality blocks for programming and managing, the good blocks within the partially applicable block program units may still be utilized, so that the good blocks within the flash memory module may be sufficiently utilized, and waste of the storage volume is then avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing blocks, suitable for a flash memory module, the method for managing blocks comprising:
dividing a plurality of flash memories of the flash memory module into a plurality of block program units, and recording blocks mapped to each of the block program units, wherein each of the block program unit maps to at least two blocks;
respectively judging available states of the block program units according to good or bad states of the blocks;
recording good blocks within the block program units; and
providing the block program units according to the record for being written with data.

2. The method for managing blocks as claimed in claim 1, further comprising marking the block program units to be applicable block program units when the blocks within the block program units are all good blocks, and marking the block program units to be partially applicable block program units when the blocks within the block program units are partially good blocks.

3. The method for managing blocks as claimed in claim 2, further comprising respectively mapping the good blocks within the partially applicable block program units to a block program unit for being written with data.

4. The method for managing blocks as claimed in claim 2, further comprising mapping the good blocks within the partially applicable block program units to a block program unit in a minimum unit of designed number of blocks of each block program unit for being written with data.

5. The method for managing blocks as claimed in claim 2, wherein the blocks mapped to each of the block program units are recorded into an applicable block program unit table, and the available states of the block program units are marked into the applicable block program unit table with a plurality of flags.

6. The method for managing blocks as claimed in claim 5, wherein the good blocks within the partially applicable block program units are recorded into a partially applicable block table.

7. The method for managing blocks as claimed in claim 6, further comprising storing the applicable block program unit table and the partially applicable block table into system blocks of the flash memory.

8. A flash memory controller, suitable for a storage device having a flash memory module, the flash memory controller comprising:
a micro processing unit;
a flash memory interface, for accessing the flash memory module;
a buffer memory, for temporarily storing data; and
a memory management module, for dividing a plurality of flash memories of the flash memory module into a plurality of block program units, recording blocks mapped to each of the block program units, respectively judging available states of the block program units according to good or bad states of the blocks, recording good blocks within the block program units and providing the good blocks within the block program units for being written with the data according to the record when writing data in the flash memory module,
wherein each of the block program unit maps to at least two blocks.

9. The flash memory controller as claimed in claim 8, wherein the memory management module marks the block program units to be applicable block program units when the blocks within the block program units are all judged to be good blocks, and marks the block program units to be partially applicable block program units when the blocks within the block program units are judged to be partially good blocks.

10. The flash memory controller as claimed in claim 9, wherein the memory management module respectively maps the good blocks within the partially applicable block program units to a block program unit for being written with data.

11. The flash memory controller as claimed in claim 9, wherein the memory management module maps the good blocks within the partially applicable block program units to a block program unit in a minimum unit of designed number of blocks of each block program unit for being written with data.

12. The flash memory controller as claimed in claim 9, wherein the memory management module records the blocks mapped to each of the block program units into an applicable block program unit table, and marks the available states of the block program units into the applicable block program unit table with a plurality of flags.

13. The flash memory controller as claimed in claim 12, wherein the memory management module records the good blocks within the partially applicable block program units into a partially applicable block table.

14. The flash memory controller as claimed in claim 13, wherein the memory management module stores the applicable block program unit table and the partially applicable block table into system blocks of the flash memory.

15. The flash memory controller as claimed in claim 8, wherein the flash memories are single level cell (SLC) NAND flash memories or multi level cell (MLC) NAND flash memories.

16. The flash memory controller as claimed in claim 8, wherein the storage device is a USB flash disk, a flash memory card or a solid state drive.
